(19) United States
(12) Patent Application Publication
(10) Pub. No.: US 2024/0399334 A1
(43) Pub. Date: Dec. 5, 2024

(54) VIBRATIONAL MICROCAVITY MODIFIED CHEMICAL REACTIONS

(71) Applicant: UCHICAGO ARGONNE, LLC, Chicago, IL (US)

(72) Inventors: Xuedan Ma, Woodridge, IL (US); Yulei Wang, Westmont, IL (US)

(21) Appl. No.: 18/203,540

(22) Filed: May 30, 2023

(51) Int. Cl. B01J 19/12

(52) U.S. Cl. CPC B01J 19/128; B01J 2219/1203

(57) ABSTRACT

Provided herein are devices for utilizing vibrational strong coupling (VSC) in a chemical reaction comprising a reaction chamber defined in a housing, at least one inlet for introducing one or more reactants into the reaction chamber, at least one outlet for removing one or more reactants and/or one or more reaction products form the reaction chamber, and a window defined on opposed first and second sides of the housing and comprising a material which does not strongly absorb infrared radiation and arranged such that infrared radiation directed from a source outside of the housing can enter into the reaction chamber. Also provided are methods of modifying chemical reactions as well as catalyzing chemical reactions.

### STATEMENT OF GOVERNMENT SUPPORT

This invention was made with government support under Grant No. DE-AC02-06CH11357, awarded by the Department of Energy, and Grant No. CBET-2025214, awarded by the National Science Foundation. The government has certain rights in the invention.

### FIELD

The disclosure relates generally to devices, and methods thereof, for using infrared radiation in chemical reactions. More particularly, the disclosure relates to devices, and methods thereof, for modifying and/or catalyzing ground state chemical reactions.

### BACKGROUND

The modification of chemical reaction rates, either increasing or decreasing, is an important area of study. Numerous chemical reactions present challenges for industrial and academic applications alike, owning to the onerous amounts of energy and time required, often including safety concerns. Catalysts are an approach to modifying chemical reactions by providing new mechanisms for chemical processes. However, careful study of chemical reactions and exhaustive searching for catalysts are generally required to address these concerns.

Structured local electromagnetic fields have been widely used to modify the interaction strength of a dipole with light in order to overcome limitations imposed by the naturally small value of the fine structure constant. When the interaction between the dipole and photons occurs at a rate faster than the dissipation rates of the system, it enters the so-called strong coupling (SC) regime, in which new eigenstates called cavity polaritons are formed. The realization of SC in solid state systems such as semiconductors and superconductors have enabled the observation of numerous exotic phenomena such as polariton condensation and superfluidity, photon blockade, extreme nonlinear optics, and long-distance energy transfer.

Vibrational strong coupling (VSC) i.e., when infrared photons are used, has emerged as a means for modifying chemical reactivity. Due to a lack of fundamental understanding, numerous theoretical models have attempted to rationalize preliminary results and provide further guidance. However, these theoretical models have yet to reconcile with experimental observations of both reaction rate acceleration and deceleration in adiabatic reactions upon resonant VSC. Moreover, the application of VSC to liquid phase reactions is considered much more complex due to unavoidable molecular rotations and intermolecular collisions that occur. These aspects of liquid phase chemical reactions change the instant dipole orientations and thermodynamic states of the systems compared to solid-state systems.

Despite the intriguing discoveries and progresses made in recent years, the basic principles governing polaritonic chemistry are still inconclusive. SC between a cavity mode and N molecular transitions gives rise to two bright polaritonic states that are delocalized over all the resonant molecules, as well as N-1 dark states with energy distributions resembling those of the molecules. It is unclear what roles the polaritonic bright and dark states play, and how they conjointly affect the chemical landscapes. For instance, theoretical studies based on the dynamical caging effect and quantum electrodynamical density functional method have contradicted theoretical models considering vibrational dissipation.

### SUMMARY

Thus, a device that can catalyze chemical reactions using infrared (IR) radiation is desirable.

A device for utilizing vibrational strong coupling (VSC) in a chemical reaction in accordance with the disclosure can include a reaction chamber defined in a housing; at least one inlet for introducing one or more reactants into the reaction chamber; at least one outlet for removing one or more reactants and/or one or more reaction products form the reaction chamber; and a window defined on opposed first and second sides of the housing and comprising a material which does not strongly absorb infrared radiation and arranged such that infrared radiation directed from a source outside of the housing can enter into the reaction chamber. The reaction chamber has a volume defined between the first and second opposed sides arranged parallel to one another and separated by a spacer a selected distance. The selected distance is determined based upon a target wavelength to resonate within the reaction chamber when radiation having the target wavelength and non-target wavelengths enters the reaction chamber through the window. The first and second opposed sides each comprise first and second inner surfaces, which each comprise a passivation layer arranged on a resonating layer such that the passivation layer defines an internal surface of the reaction chamber.

In accordance with the disclosure, a method of modifying a chemical reaction in a device having a reaction chamber defined by first and second opposed sides, each including a resonating surface arranged parallel to one another, can include introducing a reaction mixture into the reaction chamber, wherein the reaction mixture comprises at least one modulating reactant; irradiating the reaction chamber with a radiation source having target and non-target wavelengths, wherein radiation passes through at least one of the opposed resonating surfaces and the target wavelength of the radiation source resonates within the reaction chamber and the non-target wavelengths pass through the reaction chamber, wherein the target wavelength is selected based on a vibrational mode of the at least one modulating reactant to thereby modify the chemical reaction for production of one or more reaction products; and removing one or more reactants and/or one or more reaction products from the reaction chamber; wherein: modifying the chemical reaction comprises increasing or decreasing the rate of the chemical reaction, the target wavelength is tuned or de-tuned to the vibrational mode of the at least one modulating reactant, the chemical reaction is a ground state chemical reaction, and the target wavelength is in the mid-infrared or far-infrared region.

In accordance with the disclosure, a method of catalyzing a chemical reaction in a device having a reaction chamber defined by first and second opposed sides, each including a resonating surface arranged parallel to one another, can include introducing a reaction mixture into the reaction chamber, wherein the reaction mixture comprises at least one modulating reactant; irradiating the reaction chamber with a radiation source having target and non-target wavelengths, wherein radiation passes through at least one of the opposed resonating surfaces and the target wavelength of the radiation source resonates within the reaction chamber and the non-target wavelengths pass through the reaction chamber, wherein the target wavelength is selected based on a vibrational mode of the at least one modulating reactant to thereby modify the chemical reaction for production of one or more reaction products; and removing one or more reactants and/or one or more reaction products form the reaction chamber; wherein: the concentration of the at least one modulating reactant in the reaction chamber is in a range of about 0.001 mol % to about 100 mol %, the target wavelength is tuned to the vibrational mode of the at least one modulating reactant, the chemical reaction is a ground state chemical reaction, and the target wavelength is in the near-infrared, mid-infrared, or far-infrared region.

### BRIEF DESCRIPTION OF THE DRAWINGS

FIG. 1A. Photograph of the components for assembling a device of the disclosure.

FIG. 1B. Picture of the fully assembled device of the disclosure.

FIG. 1C. IR transmission spectrum of an empty cavity. The average free spectral range is ˜725 cm⁻¹.

FIG. 2. Top curve: IR transmission spectrum of a mixture of 0.2 V₀ D₂O and 0.8 V₀ IPA. The O-D stretching mode in D₂O (˜2500 cm⁻¹), C—H stretching mode in IPA (˜2970 cm⁻¹), and B—H stretching mode (˜2250-2380 cm⁻¹) in NH₃BH₃ are labeled. Bottom curve: IR transmission spectrum of the 0.2 V₀ D₂O, 0.8 V₀ IPA, and NH₃BH₃ mixture when the O-D stretching mode at ˜2500 cm⁻¹ is strongly coupled to a cavity mode. Dashed line: Transfer matrix simulation of the spectrum.

FIG. 3. Reaction time dependent IR transmission spectra of a mixture of 1M NH₃BH₃, 0.2V₀ D₂O, and 0.8V₀ IPA, for an inside-cavity experiment with Δ₀˜0.

FIG. 4. In ω_{c} plotted as a function of the reaction time for a mixture of 1M NH₃BH₃ in 0.3 V₀ D₂O and 0.7 V₀ IPA

FIG. 5. Time dependent IR absorption spectra of a 0.2 V₀ D₂O and 0.8 V₀ IPA mixture inside a cavity with the O-D stretching mode of D₂O tuned into resonance with the cavity mode.

FIG. 6. Rabi splitting (triangle) and spectral linewidth of the O-D stretching mode (circle) at various concentrations of D₂O. The linewidths are calculated from absorbance spectra. The solid line is a linear fit, while the dashed line is a guide to the eye. The gray dashed line corresponding to η=0.1 marks the onset of ultra-strong coupling.

FIG. 7. Reaction rate ratios between inside cavity and non-cavity reactions, K_{inside cavity}/K_{outside cavity}, for 0.5V₀ D₂O plotted as a function of the initial mode position (ω₀+Δ₀). The solid line represents the corresponding IR absorption spectra of the O-D stretching band.

FIG. 8. Reaction time dependent In ω_{c} values for Δ₀<0, 0.2V₀ D₂O inside cavity reaction (circle) and Δ₀<0, 0.5V. D₂O inside cavity reaction (diamond), as well as a non cavity reaction (square).

FIG. 9. Non-cavity reaction rate constants as a function of the square root of D₂O concentration, [D₂O]^{1/2}.

FIG. 10. Reaction rate ratios between inside cavity and non-cavity reactions, k_{inside cavity}/K_{outside cavity}, as a function of Rabi Splitting.

FIG. 11. Simplified sketch of population transfer and decay processes when polaritonic bright and dark states overlap.

FIG. 12. Simplified sketch of population transfer and decay processes when polaritonic bright states are separated from polaritonic dark states.

### DETAILED DESCRIPTION

Devices and methods of the disclosure can advantageously allow for the utilization of vibrational strong coupling (VSC) in a chemical reaction. The device includes a reaction chamber with opposed windows that are arranged parallel to one another. The windows do not strongly absorb infrared radiation. The windows have first and second inner surfaces, respectively, separated by a selected distance, which is determined based upon a target wavelength to resonate within the reaction chamber.

According to methods of the disclosure, chemical reactions can be modified using a device in accordance with the disclosure. A reaction mixture, having at least one modulating reactant, can be introduced into the reaction chamber. The reaction chamber can be irradiated with a radiation source having target and non-target wavelengths, wherein by virtue of the selected distance between the windows, the target wavelength of the radiation source is caused to resonate within the reaction chamber and the non-target wavelengths pass through the reaction chamber, thereby modifying the chemical reaction for production of one or more reaction products. The target wavelength can be selected based on a vibrational mode of the at least one modulating reactant and can be tuned or de-tuned to decrease or increase the rate of a chemical reaction.

According to methods of the disclosure, chemical reactions can be catalyzed using a device having a reaction chamber defined by opposed resonating surfaces arranged parallel to one another. A reaction mixture, having at least one modulating reactant, can be introduced into the reaction chamber. The reaction chamber can be irradiated with a radiation source having target and non-target wavelengths, wherein the target wavelength of the radiation source resonates within the reaction chamber and the non-target wavelengths pass through the reaction chamber to thereby modify the chemical reaction for production of one or more reaction products. The target wavelength is tuned to a vibrational mode of the at least one modulating reactant.

Advantageously, the devices and methods of the disclosure can increase and decrease chemical reaction rates, as well as catalyze chemical reactions, for any ground state chemical reaction, by tuning or de-tuning the target wavelength to the selected vibrational mode. Based on the vibrational modes of the modulating reactants, the target wavelength can be determined. The distance between the opposed resonating surfaces of the reaction chamber is modified such that the target wavelengths will be in resonance with the reaction chamber. By tuning or de-tuning the wavelength to the selected vibrational mode, the reaction rate can be modified, or the reaction can be catalyzed.

### Device of the Disclosure

A device in accordance with the disclosure can include a reaction chamber defined in a housing, at least one inlet for introducing one or more reactants into the reaction chamber, at least one outlet for removing one or more reactants and/or one or more reaction products from the reaction chamber, and the reaction chamber comprises first and second opposed sides, each opposed side comprising a window and having first and second inner surfaces, respectively.

The reaction chamber has an interior volume extending the distance between first and second opposed sides, which are arranged parallel to one other and separated by a spacer. For example, the reaction chamber can have a volume in the range of 1 mm³ to 1 dm³. For example, the reaction chamber can have a volume in the range of 1 mm³ to 1 cm³.

The spacer separates the inner surfaces of the first and second opposed sides by a selected distance that is determined based upon a target wavelength to resonate within the reaction chamber. For example, the spacer can have a thickness in the range of 1 μm to 1 cm. The spacer can be formed of any chemically inert material. For example, the spacer can be biaxially-oriented polyethylene terephthalate or polytetrafluoroethylene.

The first and second opposed sides comprise first and second inner surfaces which each comprise a passivation layer arranged on a resonating layer such that the passivation layer defines an internal surface of the reaction chamber.

The resonating layer can be formed of a material that is capable of resonating with infrared radiation at a target wavelength and can be deposited onto the window. For example, the resonating layer can be Au, Ag, TiO₂/Ag/TiO₂, or ZnS/Ag/ZnS. The resonating layer can have any thickness required. For example, the resonating layer has a thickness in the range of 1 nm to 1 μm.

The passivation layer can be formed of a material that is chemically inert and can be deposited onto the resonating layer. For example, the passivation layer is SiO₂. The passivation layer can have any thickness required. For example, the passivation layer has a thickness in the range of 1 nm to 10 μm.

The window is formed of a material that does not strongly absorb infrared radiation and is arranged such that infrared radiation directed from a source outside the housing can enter into the reaction chamber. For example, the window can be float zone Si, CaF₂, BaF₂, ZnSe, NaCl, KBr, or UV Quartz. The window can have any thickness required. For example, the window has a thickness of 10 μm to 10 mm.

The housing can be formed of any material that is chemically inert and can withstand high pressure. The housing can have any suitable thickness depending on the structural stability and pressure requirements desired. For example, the pressure in the housing can be in the range of about 0.1 psi to about 100 psi. For example, the sides of the housing have a thickness in the range of 1 mm to 10 cm.

The inlet and outlet of the device are formed of a material that is chemically inert and any required dimensions for achieving a desired flow or for connection to various known pumps and other pumping apparatus. For example, the inlet and outlet can have the same bore diameter or different bore diameters. For example, the inlet and outlet have a bore diameter in the range of 1 mm to 10 cm.

The reaction chamber performs as a Fabry-Pérot cavity. Fabry-Pérot (FP) cavities, whose mode frequencies follow ω_{c}=m/(2 nL), with m being the mode order, n and L the filling medium refractive index and cavity length, respectively, have the property that when the medium between the windows of cavity is transparent, the cavity has a high transmissivity at wavelengths for which an integral number of wavelengths can be contained between the windows, and the reflection of the cavity is high for other non-target wavelengths. When wavelengths resonate within the cavity, the amplitude of the radiation in the cavity can increase by two or more orders of magnitude.

The device of the disclosure can be tailored to encompass any target wavelength in the infrared region of the electromagnetic spectrum. The target wavelength is determined by selecting a vibrational mode of a reactant in the chemical reaction in the device. The vibrational mode of the reactant can be determined from an infrared spectrum of the reactant. For ground state chemical reactions, where the energy of the vibrational modes is quantized and sufficient population of specific vibrational modes is required to break chemical bonds, the device of the disclosure can concentrate infrared radiation at specific frequencies and thereby modify chemical reactions by modifying the population of specific vibrational modes of at least one reactants and affect reaction rates.

Based on the target wavelength, the thickness of the spacer can be adjusted as necessary to bring the target wavelength into resonance with the reaction chamber. When the reaction chamber is in resonance, rapid exchange of photons with reactants contained in the chamber (with photon exchange rates faster than any dissipation process), matter can enter into the so-called “strong coupling” regime with the surrounding electromagnetic field which leads to the formation of two new eigenstates separated by the Rabi splitting energy, so called polaritonic bright and dark states.

The chemical reaction can be monitored with IR transmission spectra. Typically, changes in absorbance are used to calculate reaction rates. However, variations in the reflectivity of the device of the disclosure over the course of the chemical reaction, as well as spectral overlap between the reactant vibrational modes and cavity modes, preclude the collection of accurate absorbance data. Consequently, cavity mode shifts are used to derive reaction rates.

Due to the difference in the refractive indices of the reactants and products, mode shifts are observed as the reaction progresses. In order to find the correlation between the cavity resonance frequency, ω_{c}, at time t, and the average reaction rate, k, over a specific period of reaction time, it is assumed that the refractive index of the mixture at the beginning of the reaction is:

$${n}_{0} = {x}_{0} {n}_{R} + {y}_{0} {n}_{P} + {z}_{0} {n}_{S} \qquad ( 1 )$$

with x₀, y₀, and z₀ being the initial mole percents of the reactants, products, and solvent, and n_{R}, n_{P}, and n_{S} being the refractive indices of the reactants, products, and solvent, respectively. At time t, the refractive index of the mixture changes to

$${n}_{t} = x {n}_{R} + y {n}_{P} + z {n}_{S} \qquad ( 2 )$$

where x, y, and z are the mole percents of the reactants, products, and solvent at time t. In a first approximation, changes in the mole percent of solvent throughout the reaction were neglected, i.e. z˜z₀, given the small concentration of reactant used and the corresponding small percent of product generated. Therefore, over reaction time t, change in the refractive index can be simplified as

$${n}_{t} - {n}_{0} = ( x - {x}_{0} ) {n}_{R} + ( y - {y}_{0} ) {n}_{P} \qquad ( 3 )$$

Since the product ratio is constant, x−x₀=−η(y−y₀), where n is a constant, the following is derived:

$$\frac{x}{{x}_{0}} = \frac{{n}_{t} - {n}_{0}}{{x}_{0} ( {n}_{R} - {n}_{P} / η )} + 1 \qquad ( 4 )$$

In parallel, from the FP cavity mode frequency, the following is derived

$${n}_{t} = \frac{m}{2 {ω}_{c} L} \qquad ( 5 )$$

$$and$$

$${n}_{0} = \frac{m}{2 {ω}_{c , 0} L} \qquad ( 6 )$$

Hence,

$${n}_{t} - {n}_{0} = \frac{m}{2 L} ( \frac{1}{{ω}_{c}} - \frac{1}{{ω}_{c , 0}} ) \qquad ( 7 )$$

If the reaction follows pseudo-first order kinetics, it can be derived that

$$ln \frac{x}{{x}_{0}} = - k t \qquad ( 8 )$$

Taken together, from equations (4), (7), and (8), the following is obtained

$$ln {ω}_{c} = - ln [ {e}^{- kt} + C ] + B \qquad ( 9 )$$

where C and B are both constants.

Using equation (9), k can be determined by plotting ln ω_{c} as a function of reaction time.

### Methods of the Disclosure

A method of modifying chemical reactions in a device in accordance with the disclosure can include introducing a reaction mixture into the reaction chamber defined by opposed first and second sides, each including a resonating surface arranged parallel to one another, irradiating the reaction chamber with a radiation source having target and non-target wavelengths, and removing one or more reactants and/or one or more reaction products from the reaction chamber.

The reaction mixture can include at least one modulating reactant. The target wavelength is selected based on the vibrational mode of the at least one modulating reactant. The target wavelength can be in the mid-infrared or far-infrared region.

The radiation passes through at least one of the opposed resonating surfaces and the target wavelength of the radiation source resonates within the reaction chamber and the non-target wavelengths pass through each of the first and second opposed sides of the reaction chamber, thereby modifying the chemical reaction for production of one or more reaction products.

The method of modifying a chemical reaction includes increasing or decreasing the rate of a ground state chemical reaction. The chemical reaction rate is increased or decreased by tuning or de-tuning the target wavelength to the vibrational mode of the at least one modulating reactant.

A method of catalyzing a chemical reaction in a device in accordance with the disclosure can include a reaction chamber defined by opposed resonating surfaces arranged parallel to one another, introducing a reaction mixture into the reaction chamber, irradiating the reaction chamber with a radiation source having target and non-target wavelengths, and removing one or more reactants and/or one or more reaction products from the reaction chamber.

The reaction mixture can include at least one modulating reactant. The concentration of the at least one modulating reactant in the reaction chamber can be in the range of about 0.001 mol % to about 100 mol %.

The target wavelength is selected based on the vibrational mode of the at least one modulating reactant. The target wavelength is in the near-infrared, mid-infrared or far-infrared region.

The radiation passes through at least one of the opposed resonating surfaces and the target wavelength of the radiation source resonates within the reaction chamber and the non-target wavelengths pass through each of the first and second opposed sides of the reaction chamber, thereby modifying the chemical reaction for production of one or more reaction products.

The method of catalyzing a chemical reaction includes tuning the target wavelength to the vibrational mode of the at least one modulating reactant.

In the methods of the disclosure, simultaneous rate modifications and resonant effects can be observed and depend on Rabi splitting and/or mode tuning/de-tuning. In methods of the disclosure, the reaction rate is closely related to the overlap between polaritonic dark and bright states.

Polaritonic states result from the strong coupling of photons with electric or magnetic dipoles. Strong coupling between a cavity mode and N molecular transitions gives rise to two bright polaritonic states that are delocalized over all the resonant molecules, as well as N-1 dark states with energy distributions resembling those of the molecules. The polaritonic bright states can emit light i.e., IR photons, whereas the polaritonic dark states cannot emit light (hence dark). Without intending to be bound by theory, it is predicted that the bright polaritonic state can inhibit a reaction, while a dark polaritonic state may accelerate it.

Under strong coupling, the coupling strength exceeds the dissipation rates of the system and the energy is therefore coherently exchanged between atom and cavity photon. The Rabi splitting refers in particular to the energy separation between the polaritonic bright and dark states. The Rabi splitting can be determined from the energy separation between the P+ and P− peaks, as shown in FIG. 2.

The mode tuning/de-tuning refers to the difference between the target wavelength in resonance with the cavity and the vibrational mode of the at least one reactant. This can be accomplished by changing the size of the spacer, and consequently the resonant frequency.

At small Rabi splitting, Ω, and/or large mode detuning, dark polaritonic states predominate due to substantial overlap with the polaritonic bright states, such that the polaritons can readily dephase into the polaritonic dark state and thermally dissipate, resulting in an acceleration in reaction rates. At large Rabi splitting and/or mode tuning, the resonant effect dominates over dark state-related thermalization due to little or no overlap between the polaritonic bright and dark states, resulting in a deceleration of reaction rate.

In chemical reactions, population of specific vibrational modes determine what chemical bonds break. By populating specific vibrational modes of at least one reactant, the chemical bonds broken can be modified. Accordingly, by changing the chemical bonds broken in the chemical reaction, the chemical reaction proceeds via a different reaction step pathway. By definition, catalysts modify the reaction pathway of a chemical reaction. As a result, the devices and methods of the disclosure can act as catalysts for ground state chemical reactions.

### EXAMPLES

The following examples are provided for illustration and are not intended to limit the scope of the invention.

### Materials and Methods

### Assembling the Device of the Disclosure

A GS20590 Series (Specac Ltd. UK) microfluidic FTIR flow cell was modified with a pair of Si windows and arranged parallel to one another. Due to their chemical inertness, low toxicity, and mechanical stability, undoped float zone silicon wafers (Resist >20000 ohm cm) were fabricated to serve as the windows for the FTIR flow cell. To prepare a pair of windows, a S1813 photoresist layer was spin coated onto a Si wafer followed by baking at 110° C. for 3 mins. The Si wafer was then cut to match the dimensions of the flow cell and two holes were drilled in one of the windows to act as the inlet and outlet. Next, the S1813 photoresist layer was removed using 1165 at 90° C., followed by thorough cleaning using acetone and isopropanol. For the assembly of the device, a pair of Si windows were coated with 10 nm Au films and 100 nm SiO₂ passivating layers using sputtering systems from AJA International Inc. and Kurt J. Lesker Company, respectively. The flow cell was further augmented by incorporating a 6 μm Mylar spacer (Specac Ltd. UK) between the Si windows. The 6 μm thick spacer was chosen to ensure sufficient free spectral ranges (˜725 cm⁻¹) to accommodate mode detuning and to avoid unintentional coupling between cavity modes and vibrational modes aside from the designated one.

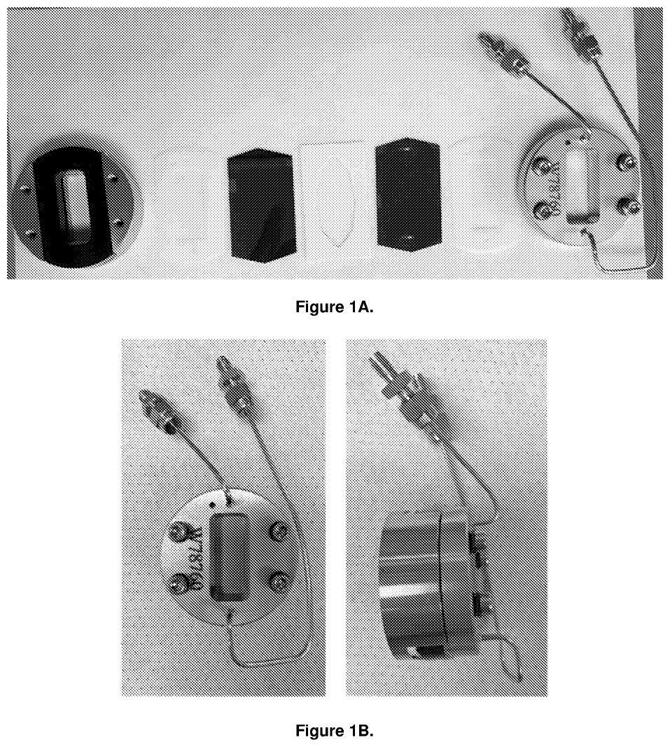

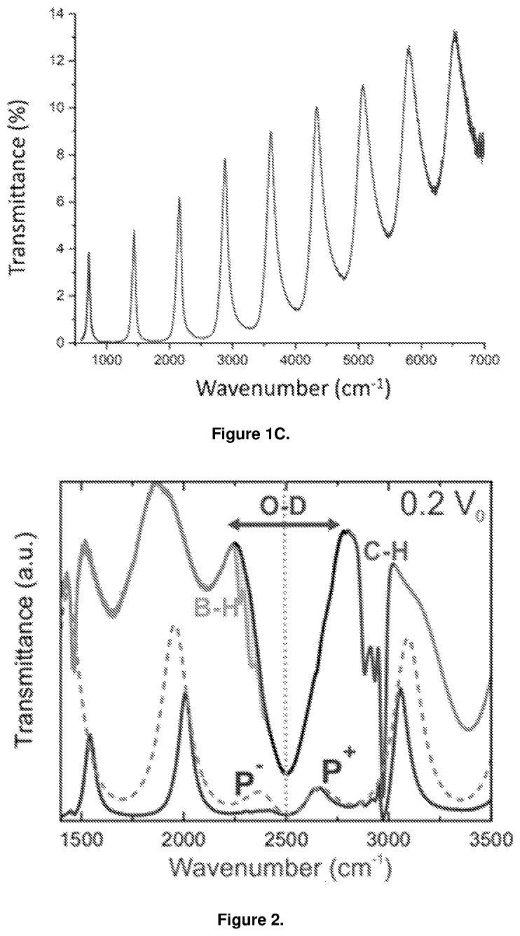

An example of the components and the assembled device are shown in FIGS. 1A and 1B, respectively. The modified FTIR flow cell formed a FP cavity which was fine adjusted until desired resonance conditions were achieved using the four screws of the flow cell. A representative IR transmission spectrum of an as-assembled empty cavity is shown in FIG. 1C.

### Reagents

Ammonia borane (H₃N—BH₃), deuterium oxide (D₂O) and isopropanol (IPA) were purchased from Sigma-Aldrich.

### Monitoring Reaction Progression

IR transmission and absorption spectra with a 2 cm⁻¹ resolution and each with over 64 scans were recorded at regular intervals (5 mins) using a standard FTIR spectrometer (Nicolet 6700).

### NMR Characterization

480 μL solutions of ammonia borane (1 M) using H₂O and D₂O as the solvents, respectively, were used for the NMR measurements. After storing the solutions for 12 days, their ¹H and ¹¹B NMR spectra were taken with a Bruker NMR spectrometer, each using 120 μL dimethyl sulfoxide-de (Sigma-Aldrich) as the locking solvent.

### Numerical Simulations

The finite-difference time-domine (FDTD) method (Lumbrical) was used to simulate the electric field distributions inside a FP cavity. In a typical simulation, a Gaussian source was used to illuminate the cavity. PML and periodic boundary conditions were used for the directions perpendicular to and along the cavity. A mesh size of 10 nm was used for the cavity region. The transfer matrix simulations were performed using a previously described model. (Wiesehan et al. J. Chem. Phys. 2021, 155, 241103)

### Example 1: Hydrolysis of Ammonia Borane (H₃N—BH₃) Using the Device of the Disclosure

### Solution Preparation

At room temperature (˜23° C.), a 1 M ammonia borane solution was prepared by dissolving ammonia borane in a mixture of D₂O and isopropanol. IPA was chosen as the reagent due to its relatively similar solvent polarity compared to D₂O (0.546 for IPA vs 0.991 for D₂O), and lack of strong absorption bands in the frequency window for D₂O. (Reichardt, C. Solvents and Solvent Effects in Organic Chemistry, Third Edition; WILEY-VCH: Marburg, Germany, 2002)

### Determining Target Wavelength

After shaking the mixture for several seconds, the solution was immediately injected into the device. The device was then sealed using Parafilm in less than 5 mins. Next, IR transmission and absorption spectra were recorded.

The cavity length was fine-tuned by adjusting the screws on the device, and the m=5 cavity mode was used to couple to the O-D stretching mode. When the cavity mode was tuned into resonance with the vibrational mode (i.e. detune Δ₀≈0), the original cavity peak split into a pair of lower (P⁻) and upper (P⁺) polaritonic states, shown in FIG. 2. Notably, the peak area of P was much smaller than that of P⁺ but, is in agreement with previous studies and is believed to be strong coupling of the vibrational mode of water with cavity modes and has been attributed to either the asymmetric stretching mode of water or the dipole self-energy term in the strong coupling (SC) regime. (Flick et al. Proc. Natl. Acad. Sci. 2017, 114, 3026-3034; Wang et al. Nat. Commun. 2021, 12, 1486; Li et al. Proc. Natl. Acad. Sci. 2020, 117, 18324-18331) The coupling-induced split features were reproduced reasonably well using the transfer matrix simulations shown in FIG. 2 (dashed line).

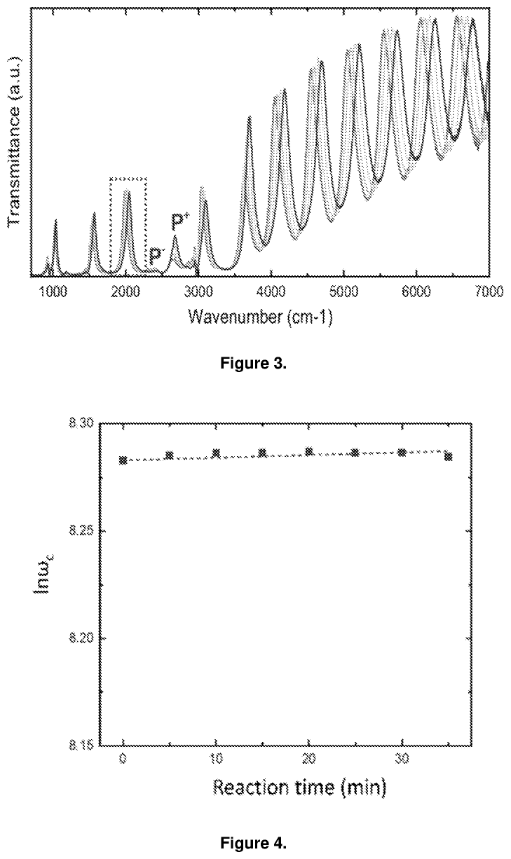

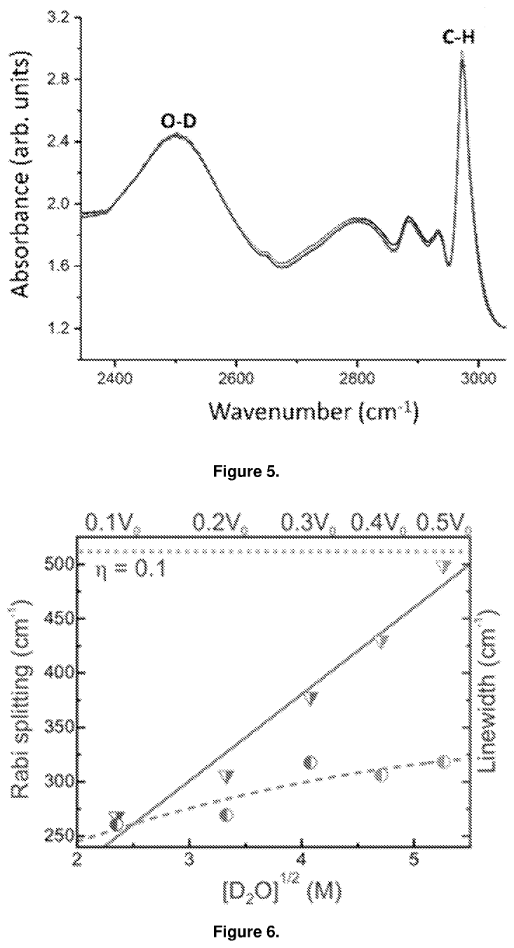

Upon injection of the reactants and IPA to the cavity, notable continuous blue shifts in the cavity modes were observed during the reaction (FIG. 3). In stark contrast, control experiments in which the cavity mode was tuned out of resonance with the O-D stretching mode exhibit minimal mode shifts (FIG. 4). In addition, injecting mixtures of D₂O and IPA without ammonia borane into the cavity also yielded no apparent peak shift (FIG. 5). These observations confirmed that the blue shifts in the IR transmission spectra occurred due to the reactions inside the cavities rather than issues such as cavity stability and sealing etc. The slightly smaller refractive index of the product compared to the reactant could account for this cavity mode shift.

Thus, Example 1 demonstrates that the device of the disclosure can catalyze the hydrolysis of ammonia borane.

### Example 2: Characterization of Hydrolysis of Ammonia Borane (H₃N—BH₃) Using the Device of the Disclosure

In a manner analogous to Example 1, the hydrolysis of ammonia borane was performed except the concentration of D₂O in the initial mixture was varied between 10% to 50% of the total volume (V₀), while the initial concentration of H₃N—BH₃ was kept the same, namely 1 M.

In order to quantitatively evaluate the reaction rates, reaction time dependent transmittance spectra were collected. Additionally, similar periods of reaction time (20-30 min) and irradiation intervals (5 min) were used. All the reactions were performed under continuous IR irradiation with similar durations of IR exposure and to avoid variations in the irradiation time due to different measurement cycles.

For 0.2V₀ D₂O, a Rabi splitting of Ω=306 cm⁻¹ was obtained which is larger than FWHMs of the O-D vibrational mode shown in FIG. 6 (circles) and the cavity mode. This confirmed the coupling to be in the strong coupling regime. An increase in the D₂O concentration, [D₂O], led to a slight broadening in the O-D vibrational mode as shown in FIG. 6 (circles), which is likely related to increased occurrence of hydrogen bonding at high D₂O concentrations. (Yamashitaa et al. J. Chem. Phys. 2007, 126, 074304) In parallel, the Rabi splitting value also increased, exhibiting a linear dependence on the square root of [D₂O] FIG. 6 (triangles). 0.1V₀ was selected as the lower limit of the D₂O concentration to ensure that the system was in the strong coupling regime. It is worth mentioning that at 0.5V₀, the ratio, η, between the coupling strength, g=2Ω, and the O-D vibrational frequency, ω₀, approaches 0.1, placing the system close to the ultrastrong coupling regime.

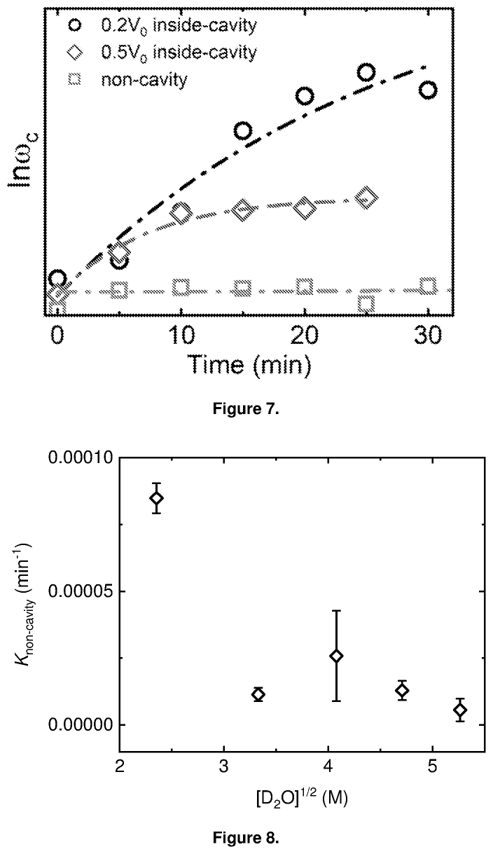

By plotting γ=ln ω_{c} as a function of the reaction time, t, the average reaction rate, k, over a specific period of reaction time was determined to be 4.58*10⁻³ min⁻¹. When the D₂O concentration was increased to 0.5V₀, which reflects an increase in the Rabi splitting from ˜306 cm⁻¹ to ˜499 cm⁻¹, acceleration in the reaction rates was still observed, but to a smaller extent (FIG. 7).

Thus, Example 2 demonstrates that the device of the disclosure can catalyze the hydrolysis of ammonia borane.

### Example 3: Hydrolysis of Ammonia Borane (H₃N—BH₃) with De-Tuned IR Radiation

Slight spectral overlap between the O—H stretching mode of IPA at ˜3400 cm⁻¹ and higher order cavity modes for D₂O can occur. In order to evaluate the effect of this spectral overlap, experiments were carried out following a similar procedure to Example 1 but the cavity mode was tuned to be selectively in resonance with the IPA O—H stretching mode rather than the O-D stretching mode from D₂O.

However, the results indicated no noticeable change in reactivity is seen when compared to reactions performed outside cavities as shown in FIG. 8. This observation suggests the importance of selecting the O-D stretching mode of D₂O in this reaction.

When the cavity mode is significantly detuned from the O-D stretching mode i.e., large mode detuning, at the beginning of the reaction i.e., Δ₀≠0, more drastic peak shifts were observed. For clarity, the energy difference between the cavity mode peak and O-D mode peak is referred to as the detuning value. For two Δ₀≠0 reactions, k values of 1.59*10⁻² min⁻¹ (Δ₀<0) and 8.29*10⁻³ min⁻¹ (Δ₀>0) were obtained, respectively. Compared with the Δ₀=0 reactions (k=4.58*10⁻³ min⁻¹), these findings suggest a potential influence of mode detuning on the reaction rates.

Thus, Example 3 demonstrates that increases in reaction rates are observed for the hydrolysis of H₃N—BH₃ in D₂O by de-coupling the frequency of the infrared radiation in the cavity mode with the O-D stretching mode from D₂O.

### Comparative Example 4: Non-Cavity Hydrolysis of Ammonia Borane (H₃N—BH₃) without Au Films

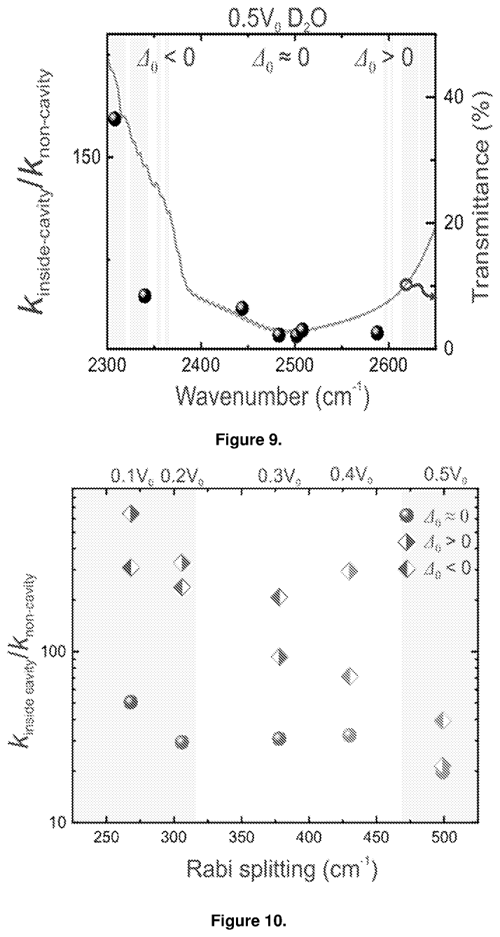

As a comparison, non-cavity experiments were carried out following a similar procedure but using windows without Au films, which required the sample to be irradiated with infrared light continuously and the reaction rates as a function of the square root of D₂O concentration are shown in FIG. 9. An average non-cavity reaction rate of 2.81*10⁻⁵ min⁻¹ was obtained. In contrast, reaction rates of 1.5*10⁻² min⁻¹ were obtained using the cavity. Thus, using the cavity and the target wavelength of the O-D stretching mode, reaction rates were increased.

Reaction rates of 0.2V₀ D₂O reactions normalized by the average non-cavity reaction rates, namely the K_{inside-cavity}/K_{non-cavity} values are shown in FIG. 7. An acceleration in the reaction rate can be observed (K_{inside-cavity}/K_{non-cavity}>1) for the various detuning values, i.e. as the magnitude of Δ₀ increases, the reaction rate is accelerated. The effect of the coupling strength was further elucidated by plotting K_{inside-cavity}/K_{non-cavity} as a function of the Rabi splitting, Ω (FIG. 10). An overall decrease in the rate ratio can be observed with increasing Rabi splitting.

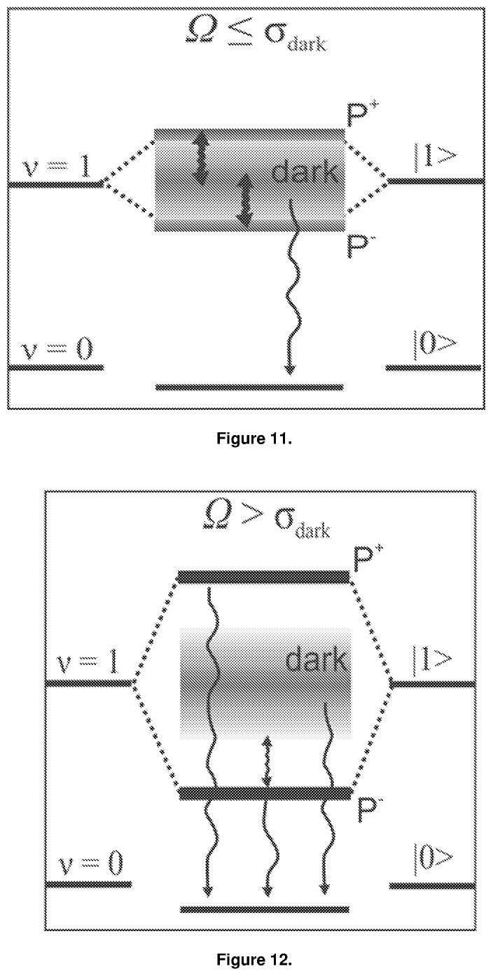

However, it was observed that when Rabi splitting is smaller or comparable to the absorption linewidth of the vibrational mode (σ_{dark}) (FIG. 11), the polaritonic bright states overlap substantially with the dark states and population transfer between the bright and dark states occurs, followed by thermal dissipation. In these cases, dark state-mediated catalytic effects are observed.

For large Rabi splitting, namely Ω>σ_{dark}, the polaritonic bright states are well isolated from the dark states and polaritonic bright state-mediated resonant phenomenon becomes more important (FIG. 12). This results in an inhibiting effect on the reaction rate. In these cases, reduced acceleration or even deceleration to the chemical reaction rates was observed.

Thus, Example 4 demonstrates that a dynamic between Rabi splitting, and tuning or de-tuning the target wavelength to the O-D stretching mode, can modify or catalyze the hydrolysis of H₃N—BH₃ in D₂O.

### Embodiments of the Disclosure

1. A device for utilizing vibrational strong coupling (VSC) in a chemical reaction, the device comprising:
a reaction chamber defined in a housing;
at least one inlet for introducing one or more reactants into the reaction chamber;
at least one outlet for removing one or more reactants and/or one or more reaction products form the reaction chamber; and
a window defined on opposed first and second sides of the housing and comprising a material which does not strongly absorb infrared radiation and arranged such that infrared radiation directed from a source outside of the housing can enter into the reaction chamber;
wherein:
the reaction chamber has a volume defined between the first and second opposed sides arranged parallel to one another and separated by a spacer a selected distance;
the selected distance is determined based upon a target wavelength to resonate within the reaction chamber when radiation having the target wavelength and non-target wavelengths enters the reaction chamber through the window, and
the first and second opposed sides each comprise first and second inner surfaces, which each comprise a passivation layer arranged on a resonating layer such that the passivation layer defines an internal surface of the reaction chamber.
2. The device of embodiment 1, wherein the pressure in the housing is in the range of about 0.1 psi to about 100 psi.
3. The device of embodiments 1 or 2, wherein each of the first and second sides of the housing has a thickness in the range of 1 mm to 10 cm.
4. The device of any one of embodiments 1-3, wherein the window has a thickness of 10 μm to 10 mm.
5. The device of any one of embodiments 1-4, wherein the window is float zone Si, CaF₂, BaF₂, ZnSe, NaCl, KBr, or UV Quartz.
6. The device of any one of embodiments 1-5, wherein each resonating layer has a thickness in the range of 1 nm to 1 μm.
7. The device of any one of embodiments 1-6, wherein each resonating layer is Au, Ag, TiO₂/Ag/TiO₂ or ZnS/Ag/ZnS.
8. The device of any one of embodiments 1-7, wherein each passivation layer has a thickness in the range of 1 nm to 10 μm.
9. The device of any one of embodiments 1-8, wherein each passivation layer is SiO₂.
10. The device of any one of embodiments 1-9, wherein the spacer has a thickness in the range of 1 μm to 1 cm.
11. The device of any one of embodiments 1-10, wherein the spacer is biaxially-oriented polyethylene terephthalate or polytetrafluoroethylene.
12. The device of any one of embodiments 1-11, wherein the chamber has a volume in the range of 1 mm³ to 1 dm³.
13. The device of any one of embodiments 1-12, wherein the chamber has a volume in the range of 1 mm³ to 1 cm³.
14. The device of any one of embodiments 1-13, wherein the inlet and outlet have the same bore diameter.
15. The device of any one of embodiments 1-14, wherein the inlet and outlet each have a bore diameter in the range of 1 mm to 10 cm.
16. A method of modifying a chemical reaction in a device having a reaction chamber defined by first and second opposed sides, each including a resonating surface arranged parallel to one another, comprising:
introducing a reaction mixture into the reaction chamber, wherein the reaction mixture comprises at least one modulating reactant;
irradiating the reaction chamber with a radiation source having target and non-target wavelengths, wherein radiation passes through at least one of the opposed resonating surfaces and the target wavelength of the radiation source resonates within the reaction chamber and the non-target wavelengths pass through the reaction chamber, wherein the target wavelength is selected based on a vibrational mode of the at least one modulating reactant to thereby modify the chemical reaction for production of one or more reaction products; and
removing one or more reactants and/or one or more reaction products from the reaction chamber;
wherein:
modifying the chemical reaction comprises increasing or decreasing the rate of the chemical reaction,
the target wavelength is tuned or de-tuned to the vibrational mode of the at least one modulating reactant,
the chemical reaction is a ground state chemical reaction, and
the target wavelength is in the mid-infrared or far-infrared region.
17. The method of embodiment 16, wherein the target wavelength is tuned to the vibrational mode of one or more reactants.
18. The method of embodiment 16 or 17, wherein the rate of the chemical reaction is decreased.
19. The method of embodiment 16, wherein the target wavelength is de-tuned to the vibrational mode of one or more reactants.
20. The method of embodiment 16 or 19, wherein the rate of the chemical reaction is increased.
21. A method of catalyzing a chemical reaction in a device having a reaction chamber defined by first and second opposed sides, each including a resonating surface arranged parallel to one another, comprising:
introducing a reaction mixture into the reaction chamber, wherein the reaction mixture comprises at least one modulating reactant;
irradiating the reaction chamber with a radiation source having target and non-target wavelengths, wherein radiation passes through at least one of the opposed resonating surfaces and the target wavelength of the radiation source resonates within the reaction chamber and the non-target wavelengths pass through the reaction chamber, wherein the target wavelength is selected based on a vibrational mode of the at least one modulating reactant to thereby modify the chemical reaction for production of one or more reaction products; and
removing one or more reactants and/or one or more reaction products form the reaction chamber;
wherein:
the concentration of the at least one modulating reactant in the reaction chamber is in a range of about 0.001 mol % to about 100 mol %,
the target wavelength is tuned to the vibrational mode of the at least one modulating reactant,
the chemical reaction is a ground state chemical reaction, and
the target wavelength is in the near-infrared, mid-infrared, or far-infrared region.
22. The method of embodiment 21, wherein the concentration of the at least one modulating reactant is in the range of about 0.001 mol % to about 100 mol %.
23. The method of any one of embodiments 16-22, wherein the at least one modulating reactant comprises one or more polar bonds.
24. The method of any one of embodiments 16-23, wherein the vibrational mode of the at least one modulating reactant is the only vibrational mode equal in energy to the target wavelength.
25. The method of any one of embodiments 16-24, comprising irradiating the reaction chamber with the infrared radiation at an interval of infrared radiation in a spectral width of 10 cm⁻¹ to 100 cm⁻¹.
26. The method of any one of embodiments 16-25, wherein the target wavelength is in the range of about 14,000 cm⁻¹ to about 10 cm⁻¹.
27. The method of embodiment 26, wherein the target wavelength is in the range of about 4,000 cm⁻¹ to about 400 cm⁻¹.
28. The method of any one of embodiments 16-27, comprising irradiating the reaction chamber for a total irradiation time of about 1 minute to about 48 hours.
29. The method of embodiment 28, wherein the total irradiation time of the chemical reaction is in a range of 1 minute to 12 hours.
30. The method of any one of embodiments 16-29, comprising irradiating the reaction chamber in one or more intervals of irradiation, wherein each interval of irradiation is about 1 second to about 10 minutes.
31. The method of embodiment 30, wherein irradiating the reaction chamber comprises two or more intervals of irradiation, each interval separated by a break in irradiation of about 1 second to about 10 minutes.

What is claimed is:

1. A device for utilizing vibrational strong coupling (VSC) in a chemical reaction, the device comprising:
a reaction chamber defined in a housing;
at least one inlet for introducing one or more reactants into the reaction chamber;
at least one outlet for removing one or more reactants and/or one or more reaction products form the reaction chamber; and
a window defined on opposed first and second sides of the housing and comprising a material which does not strongly absorb infrared radiation and arranged such that infrared radiation directed from a source outside of the housing can enter into the reaction chamber;
wherein:
the reaction chamber has a volume defined between the first and second opposed sides arranged parallel to one another and separated by a spacer a selected distance;
the selected distance is determined based upon a target wavelength to resonate within the reaction chamber when radiation having the target wavelength and non-target wavelengths enters the reaction chamber through the window, and
the first and second opposed sides each comprise first and second inner surfaces, which each comprise a passivation layer arranged on a resonating layer such that the passivation layer defines an internal surface of the reaction chamber.

2. The device of claim 1, wherein each of the first and second sides of the housing has a thickness in the range of 1 mm to 10 cm.

3. The device of claim 1, wherein the window has a thickness of 10 μm to 10 mm.

4. The device of claim 1, wherein the window is float zone Si, CaF₂, BaF₂, ZnSe, NaCl, KBr, or UV Quartz.

5. The device of claim 1, wherein each resonating layer has a thickness in the range of 1 nm to 1 μm.

6. The device of claim 5, wherein each resonating layer is Au, Ag, TiO₂/Ag/TiO₂, or ZnS/Ag/ZnS.

7. The device of claim 1, wherein each passivation layer has a thickness in the range of 1 nm to 10 μm.

8. The device of claim 7, wherein each passivation layer is SiO₂.

9. The device of claim 1, wherein the spacer has a thickness in the range of 1 μm to 1 cm.

10. The device of claim 9, wherein the spacer is biaxially-oriented polyethylene terephthalate or polytetrafluoroethylene.

11. The device of claim 1, wherein the chamber has a volume in the range of 1 mm³ to 1 dm³.

12. A method of modifying a chemical reaction in a device having a reaction chamber defined by first and second opposed sides, each including a resonating surface arranged parallel to one another, comprising:
introducing a reaction mixture into the reaction chamber, wherein the reaction mixture comprises at least one modulating reactant;
irradiating the reaction chamber with a radiation source having target and non-target wavelengths, wherein radiation passes through at least one of the opposed resonating surfaces and the target wavelength of the radiation source resonates within the reaction chamber and the non-target wavelengths pass through the reaction chamber, wherein the target wavelength is selected based on a vibrational mode of the at least one modulating reactant to thereby modify the chemical reaction for production of one or more reaction products; and
removing one or more reactants and/or one or more reaction products from the reaction chamber;
wherein:
modifying the chemical reaction comprises increasing or decreasing the rate of the chemical reaction,
the target wavelength is tuned or de-tuned to the vibrational mode of the at least one modulating reactant,
the chemical reaction is a ground state chemical reaction, and
the target wavelength is in the mid-infrared or far-infrared region.

13. The method of claim 12, wherein the target wavelength is tuned to the vibrational mode of one or more reactants thereby decreasing the rate of the chemical reaction.

14. The method of claim 12, wherein the target wavelength is de-tuned to the vibrational mode of one or more reactants thereby increasing the rate of the chemical reaction.

15. A method of catalyzing a chemical reaction in a device having a reaction chamber defined by first and second opposed sides, each including a resonating surface arranged parallel to one another, comprising:
introducing a reaction mixture into the reaction chamber, wherein the reaction mixture comprises at least one modulating reactant;
irradiating the reaction chamber with a radiation source having target and non-target wavelengths, wherein radiation passes through at least one of the opposed resonating surfaces and the target wavelength of the radiation source resonates within the reaction chamber and the non-target wavelengths pass through the reaction chamber, wherein the target wavelength is selected based on a vibrational mode of the at least one modulating reactant to thereby modify the chemical reaction for production of one or more reaction products; and
removing one or more reactants and/or one or more reaction products form the reaction chamber;
wherein:
the concentration of the at least one modulating reactant in the reaction chamber is in a range of about 0.001 mol % to about 100 mol %,
the target wavelength is tuned to the vibrational mode of the at least one modulating reactant,
the chemical reaction is a ground state chemical reaction, and
the target wavelength is in the near-infrared, mid-infrared, or far-infrared region.

16. The method of claim 15, wherein the vibrational mode of the at least one modulating reactant is the only vibrational mode equal in energy to the target wavelength.

17. The method of claim 15, comprising irradiating the reaction chamber with the infrared radiation at an interval of infrared radiation in a spectral width of 10 cm⁻¹ to 100 cm⁻¹.

18. The method of claim 15, wherein the target wavelength is in the range of about 14,000 cm⁻¹ to about 10 cm⁻¹.

19. The method of claim 15, comprising irradiating the reaction chamber for a total irradiation time of about 1 minute to about 48 hours.

20. The method of claim 15, comprising irradiating the reaction chamber in one or more intervals of irradiation, wherein each interval of irradiation is about 1 second to about 10 minutes.
